(19) United States
(12) Patent Application Publication
(10) Pub. No.: US 2024/0095720 A1
(43) Pub. Date: Mar. 21, 2024

(54) AUTOMATIC TOKEN WALLET GENERATION

(71) Applicant: TOKENFORM LLC, Denver, CO (US)

(72) Inventors: Jeffrey Binder, Denver, CO (US); Charles Hasek, Denver, CO (US); Lindsay Gardner, West Hollywood, CA (US)

(21) Appl. No.: 18/243,297

(22) Filed: Sep. 7, 2023

Related U.S. Application Data
(60) Provisional application No. 63/407,938, filed on Sep. 19, 2022.

(51) Int. Cl. G06Q 20/36; H04L 67/02

(52) U.S. Cl. CPC G06Q 20/3672; H04L 67/02; G06Q 2220/165

(57) ABSTRACT

Automatic token wallet generation includes generating a token wallet generated for a unique identifier that is associated with a person. The unique identifier may be a communication identifier like an email address, a telephone number, a social media handle, and so on. Storage space may be allocated for the token wallet and may be associated with the unique identifier. One or more NFTs (non-fungible tokens) may then be associated with the token wallet. In some examples, the token wallet may be automatically created in response to a request to associate an NFT with it. In other examples, the token wallet may be created in response to a request to perform other actions related to the token wallet.

### CROSS-REFERENCE TO RELATED APPLICATION(S)

This application is a nonprovisional patent application of and claims the benefit under 35 U.S.C. § 119(e) of U.S. Provisional Patent Application No. 63/407,938, filed Sep. 19, 2022, and titled “Automatic Token Wallet Generation”, the contents of which are incorporated herein by reference in its entirety.

### FIELD

The described embodiments relate generally to token wallets. More particularly, the present embodiments relate to automatic token wallet generation.

### BACKGROUND

A blockchain is a distributed ledger that is shared among nodes of a decentralized computer network. Blockchains are similar to databases in that they store information electronically in digital format. However, unlike a database, blockchains collect information together in groups, known as blocks. As blocks are filled they are closed, timestamped, and linked to a previously filled block. This data structure inherently makes an irreversible timeline of data when implemented in a decentralized nature.

One use of blockchains is to store non-fungible tokens (NFTs). NFTs are cryptographic assets on a blockchain with unique identification codes and metadata that distinguish them from each other. NFTs are typically used to represent rights to real world assets, such as artworks. NFTs are associated with a smart contract stored on the blockchain that controls transactions that can be performed with the NFTs and who can perform them. NFTs are accessible using private and/or public keys stored in a local and/or cloud-based token wallet assigned to the owner of the respective NFT, and ownership is tracked on the blockchain.

### OVERVIEW

The present disclosure relates to automatic token wallet generation. A token wallet is generated for a unique identifier that is associated with a person, which may be a communication identifier like an email address, a telephone number, a social media handle, and so on. Storage space may be allocated for the token wallet and may be associated with the unique identifier. One or more NFTs (non-fungible tokens) may then be associated with the token wallet.

In various embodiments, a system includes a non-transitory storage medium storing instructions and a processor. The processor executes the instructions to receive a request to provide a non-fungible token (NFT) to a person associated with a unique identifier, generate a token wallet, associate the token wallet with the unique identifier, create the NFT, and associate the NFT with the token wallet.

In some examples, the processor provides access to the token wallet via a hypertext markup language plugin. In a number of examples, the token wallet includes sub wallets. In various implementations of such examples, one of the sub wallets is a branded sub wallet.

In a number of examples, the unique identifier is a communication identifier. In some implementations of such examples, the communication identifier is at least one of an email address, a telephone number, or a social media account identifier. In various implementations of such examples, the processor transmits a notification regarding the token wallet to the communication identifier, transmits a one-time password to the communication identifier, and allows access to the token wallet upon being provided with the one-time password.

In some embodiments, a system includes a non-transitory storage medium storing instructions and a processor. The processor executes the instructions to determine that an operation requires a token wallet associated with a unique identifier, determine that the token wallet does not already exist, generate the token wallet, and associate a non-fungible token (NFT) with the token wallet.

In various examples, the operation is a first operation, the unique identifier is a first unique identifier, the token wallet is a first token wallet, and the processor determines that a second operation requires a second token wallet associated with a second unique identifier, identifies that a third token wallet associated with a third unique identifier is associated with a same person as the second unique identifier, and uses the third token wallet instead of generating the second token wallet. In a number of implementations of such examples, the processor uses the third token wallet by creating a sub wallet in the third token wallet for the second operation. In various implementations of such examples, the processor identifies that the third token wallet associated with the third unique identifier is associated with a same person as the second unique identifier by determining that a same phone number is associated with both the third unique identifier and the second unique identifier.

In some examples, the unique identifier is a frequent flyer number. In a number of examples, association of the NFT with the token wallet is usable in place of an access credential to access a computing device associated with a requestor of the operation. In some examples, the operation is generation of the NFT.

In a number of embodiments, a system includes a non-transitory storage medium storing instructions and a processor. The processor executes the instructions to receive a digital photograph to send to a person associated with a unique identifier, create a non-fungible token (NFT) and an associated smart contract relating to accessing the digital photograph, generate a token wallet that is associated with the unique identifier, and associate the NFT with the token wallet.

In some examples, the processor generates an access protected version of the digital photograph. In various implementations of such examples, the processor stores the access protected version of the digital photograph on a blockchain. In a number of implementations of such examples, the processor generates the access protected version of the digital photograph by encrypting the digital photograph and the NFT is usable to decrypt an encrypted version of the digital photograph. In some implementations of such examples, the processor generates the access protected version of the digital photograph by encrypting the digital photograph.

In various examples, the associated smart contract is operable to render the digital photograph no longer accessible.

### BRIEF DESCRIPTION OF THE DRAWINGS

The disclosure will be readily understood by the following detailed description in conjunction with the accompanying drawings, wherein like reference numerals designate like structural elements.

FIG. 1A depicts an example system.

FIG. 1B depicts a flow of using creation and minting of a smart contract and non-fungible token. The flow may be performed by the system of FIG. 1A.

FIG. 1C depicts a list of backend services. The backend services may support and/or be provided by the system of FIG. 1A.

FIG. 1D depicts mint-print-manage functions. The mint-print-manage functions may be performed and/or supported and/or provided by the system of FIG. 1A.

FIG. 2 depicts a flow chart illustrating a first example method that involves automatic token wallet generation. This method may be performed by the system of FIG. 1A.

FIG. 3 depicts example relationships among example components that may be used to implement the system of FIG. 1A.

FIG. 4 depicts a flow chart illustrating a second example method that involves automatic token wallet generation. This method may be performed by the system of FIG. 1A.

FIG. 5 depicts a flow chart illustrating a third example method that involves automatic token wallet generation. This method may be performed by the system of FIG. 1A.

FIG. 6 depicts a flow chart illustrating a fourth example method that involves automatic token wallet generation. This method may be performed by the system of FIG. 1A.

FIG. 7 depicts a flow chart illustrating a fifth example method that involves automatic token wallet generation. This method may be performed by the system of FIG. 1A.

FIG. 8 depicts a flow chart illustrating a sixth example method that involves automatic token wallet generation. This method may be performed by the system of FIG. 1A.

FIG. 9 depicts a flow chart illustrating a seventh example method that involves automatic token wallet generation. This method may be performed by the system of FIG. 1A.

FIG. 10 depicts a flow chart illustrating an eighth example method that involves automatic token wallet generation. This method may be performed by the system of FIG. 1A.

FIG. 11 depicts a flow chart illustrating a ninth example method that involves automatic token wallet generation. This method may be performed by the system of FIG. 1A.

FIG. 12 depicts a flow chart illustrating a tenth example method that involves automatic token wallet generation. This method may be performed by the system of FIG. 1A.

FIG. 13 depicts a flow chart illustrating an eleventh example method that involves automatic token wallet generation. This method may be performed by the system of FIG. 1A.

FIG. 14 depicts a flow chart illustrating a twelfth example method that involves automatic token wallet generation. This method may be performed by the system of FIG. 1A.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

Token wallets are electronic repositories associated with storage of at least one or more private keys associated with one or more NFTs (non-fungible tokens) and/or other tokens associated with one or more blockchains. One of the biggest barriers to adoption of NFTs and/or other tokens associated with one or more blockchains is token wallet creation. Token wallet creation is a technical process, involving operations such as creation of a seed phrase, that may be beyond the skill level of many users. Many users avoid NFTs and/or other tokens associated with one or more blockchains instead of figuring out how to generate a token wallet. Even for users who are capable of generating a token wallet, they may not have yet done so when another user or entity wants to associate an NFT with it. This may create a significant burden to the spread of NFTs and/or other tokens associated with one or more blockchains. Additionally, this may increase consumption of hardware and/or software resources of systems involving NFTs and/or other tokens associated with one or more blockchains due to excessive user interactions to generate token wallets, delays when token wallets have not been created when needed, and so on.

The present disclosure relates to automatic token wallet generation. A token wallet is generated for a unique identifier that is associated with a person, which may be a communication identifier like an email address, a telephone number, a social media handle, and so on. Storage space may be allocated for the token wallet and may be associated with the unique identifier. One or more NFTs may then be associated with the token wallet.

In this way, the present disclosure may provide technological solutions to token wallet creation, particularly technological solutions that arise from the technological problems introduced by users not understanding the user interfaces that can be used to create such token wallets and/or not having generated such token wallets prior to another user or entity wanting to associate an NFT with it. A system and/or device using the techniques of the present disclosure may be able to provide improved user interfaces, eliminate delays introduced by token wallets not being available when needed, and/or perform various token wallet related functions that the system and/or device would not previously have been able to perform absent the technology disclosed herein. This may enable the system and/or device to operate more efficiently while consuming fewer hardware and/or software resources as more resource consuming techniques may be omitted. Further, one or more databases and/or other components may be omitted while still enabling various token wallet related functions and/or other functions, reducing unnecessary hardware and/or software components, and providing greater system flexibility and security.

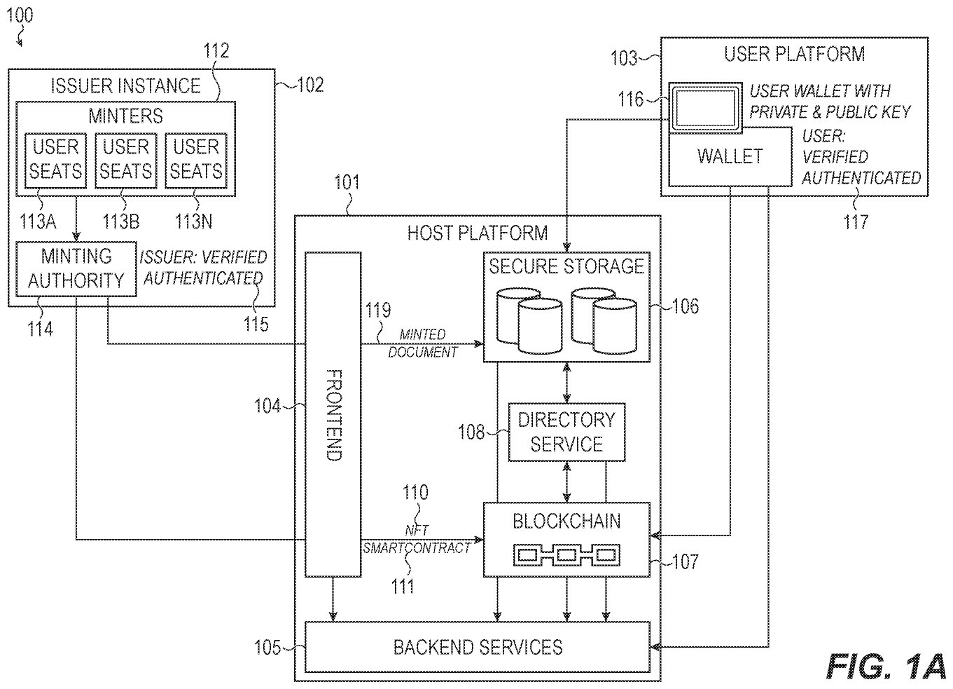

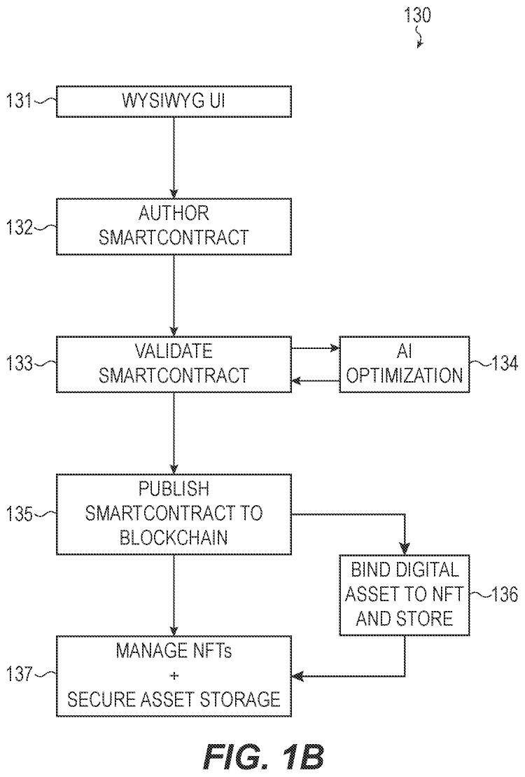

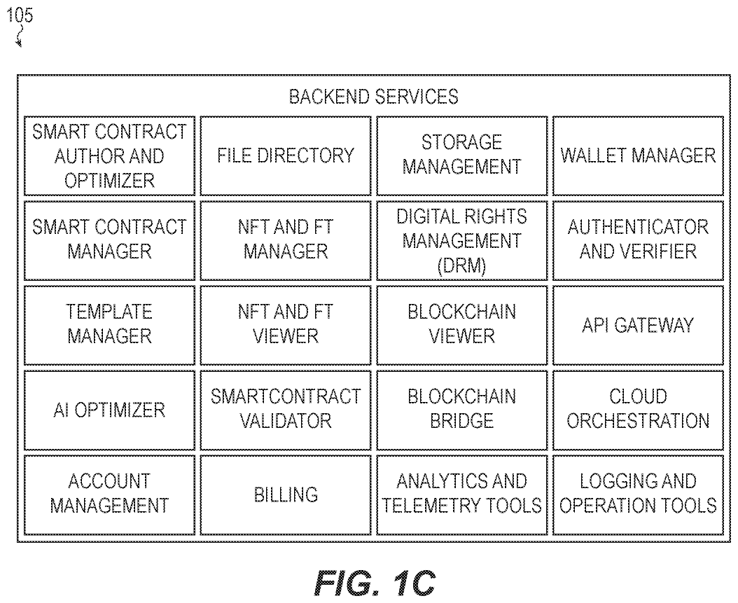

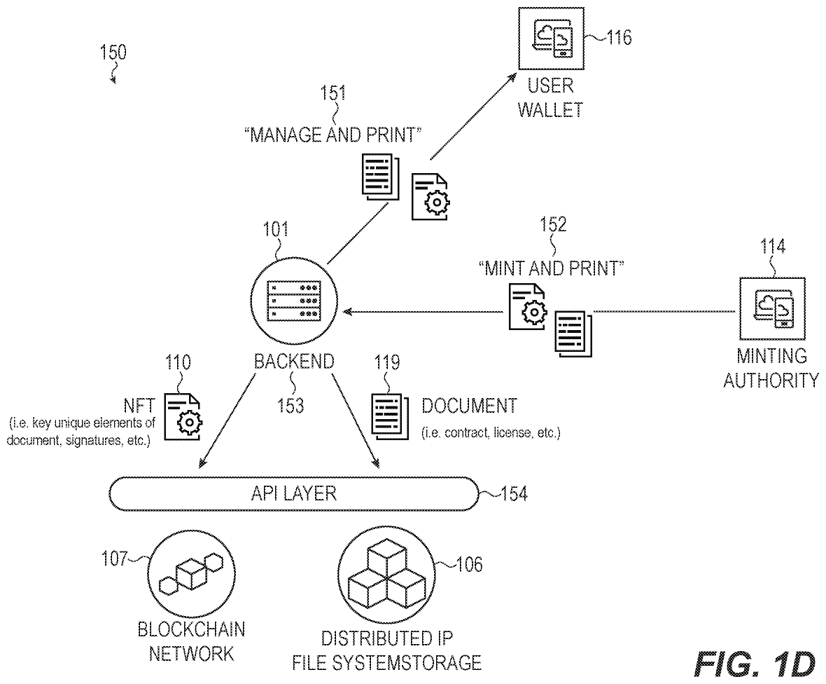

These and other embodiments are discussed below with reference to FIGS. 1A-14. However, those skilled in the art will readily appreciate that the detailed description given herein with respect to these Figures is for explanatory purposes only and should not be construed as limiting.

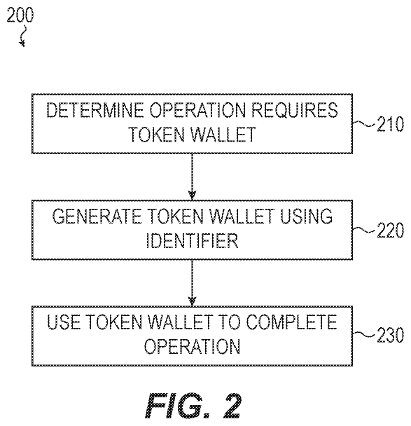

FIG. 1A depicts an example system 100. The system 100 (such as via a host platform 101) may perform automatic token wallet generation. The system 100 may generate the token wallet for a particular blockchain, such as when generation of an NFT will be stored on the particular blockchain. The system 100 may assign the token wallet a storage and/or other address tied to one or more assets on the particular blockchain. The system 100 may perform a variety of operations associated with generating and/or configuring the token wallet, such as generating a seed phrase. The system 100 may allocate a storage space in a non-transitory storage medium that is associated with the identifier and is usable for storing one or more private keys and/or other data associated with the token wallet. The identifier may be a unique identifier in that the identifier may uniquely identify a particular person or entity. For example, the unique identifier may be a person's frequent flier number, an account number, a checking account number, a savings account number, a social security number, a driver's license number, a state or federal identification number, a communication identifier (such as any identifier that may be used to communicate with the person, such as an email address, a telephone number, a social media account handle, and so on), a rewards number, and so on. The identifier may be specified in a request received to perform an operation. For example, the request may specify to create an NFT for the identifier. Examples of such operations are discussed in detail below with respect to FIGS. 2 and 4-10.

The system 100 may include a host platform 101 that is operable to create and/or perform one or more transactions and/or other actions related to one or more NFTs 110, smart contracts 111, and/or minted documents 119 on behalf of and/or for one or more other entities, such as one or more issuer instances 102, user platforms 103, intermediaries (not shown), and so on. Creation of the NFTs 110 may involve creation of one or more smart contracts 111, storage of the smart contracts 111 and/or the NFTs 110 in one or more blockchains, automatic creation and/or maintenance of one or more local and/or cloud-based token wallets (an electronic repository associated with storage of at least one or more private keys associated with one or more NFTs 110 and/or other tokens associated with one or more blockchains), and so on. In some cases, the private keys for the NFTs 110 and/or other encrypted and/or unencrypted data (such as one or more public keys, copies of the NFTs 110, payloads, and so on) may be stored in one or more local and/or cloud-based token wallets. The NFT document platform may also be operable to mint one or more documents, such as one or more birth certificates, contracts and other signed documents, titles (such as house titles, car titles, and so on), prescriptions, licenses and/or identification documents, checks, money, gift cards, and so on. The smart contracts 111 and/or NFTs 110 may correspond to the one or more minted documents 119 and may even be created using data from and/or otherwise associated with the minted documents 119. The NFTs may be usable to authenticate the minted documents 119, evidence ownership of the minted documents 119, control the ability to perform transactions regarding the minted documents 119, and so on.

For example, an online tax preparation service may be a first issuer instance 102 and a streaming television and movie service may be a second issuer instance 102. The online tax preparation service may allow a customer using the user platform 103 to create one or more NFTs and/or associated smart contracts via the host platform 101 to delegate authority to a tax preparation professional to access stored tax information for the customer in order to review the customer's tax forms. The tax professional may not have a token wallet associated with the online tax preparation service. However, the host platform 101 may have automatically created a token wallet associated with the tax professional's email address for the tax professional's streaming television and movie service account in order to store NFTs that the tax professional uses to access streaming television and movie content from the streaming television and movie service. When the customer delegates authority to the tax professional, the customer may provide the tax professional's email address. The host platform 101 may recognize that a token wallet is already associated with that email address and may associate the NFT that is accordingly created with that token wallet. However, token wallets may include hidden areas. When the tax professional accesses the token wallet for the streaming television and movie service, the tax professional may not see the NFT for the online tax preparation service. However, when the online tax preparation service associates the NFT with the token wallet, the tax professional may be sent an email notifying the tax professional that the customer has delegated the authority. The email may include a link to access the customer's tax forms, which may both send a one-time password to the tax professional's email account and prompt the tax professional to enter the sent one-time password. When the tax professional provides the sent one-time password, the online tax preparation service may allow the tax professional to access the customer's tax forms. Various configurations are possible and contemplated without departing from the scope of the present disclosure.

Although the above example is described in the context of an online tax preparation service and a streaming television and movie service, it is understood that this is an example. In various implementations, the techniques of the present disclosure may be used with anything that uses credentials. Various configurations are possible and contemplated without departing from the scope of the present disclosure.

In another example, an attorney may delegate authority to an assistant that allows the assistant to read emails in the attorney's email inbox and file the emails into one or more sub folders. However, the delegated authority may not enable the assistant to see emails in a FIRM BUSINESS sub folder or any files to which the attorney has access. This delegated authority may be more secure than the attorney simply providing the assistant the attorney's password, or simply logging onto the attorney's account and then stepping aside to allow the assistant to perform email related tasks. The attorney may submit a request to the host platform 101 to delegate the authority and the host platform 101 may generate an associated NFT. The NFT may not be directly accessible by the assistant. For example, in some implementations, a token wallet may be automatically generated by the host platform 101 for the assistant when the NFT is assigned to the assistant. The token wallet may be automatically generated and associated with a communication address associated with the assistant, such as an email address, phone number, social media messaging address, and so on. By way of illustration, the attorney may provide the assistant's email address when assigning the NFT and a token wallet associated with that email address may be generated and a notification email may be sent to the assistant at that email address. The email address may include a link to the NFT. Alternatively, the NFT may be hidden from the assistant and the link may be usable by the assistant to utilize the delegated authority. Various configurations are possible and contemplated without departing from the scope of the present disclosure.

In still another example, a hotel front desk employee may assign a hotel room to a customer for 24 hours. As part of this, the hotel front desk employee may submit a request to the host platform 101. The request may provide an email address of the customer. This may result in creation of an NFT and an associated smart contract that delegates to the customer the authority to use the room for 24 hours, after which the NFT may expire. This NFT may be associated with a token wallet that may be automatically created and associated with the email address of the customer. When the NFT is associated with the smart wallet, an email notifying the customer of the association may be sent to the email address. The email may include a link for the customer to click from a mobile computing device, which may open an app on the mobile computing device that the customer may use to unlock a door to the hotel room via Bluetooth™ and/or another wireless communication technology.

In yet other examples, a server computing device may administer a rewards program for a merchant. The rewards program may track customer purchases at a merchant and may use a host platform 101 to issue NFTs enabling customers to claim $20 in merchant merchandise for every ten purchases that the customers make from the merchant. The server computing device may receive a request from a customer to claim $20 in merchant merchandise. In response, the server computing device may determine whether or not an NFT enabling the customer to claim the $20 in merchant merchandise is associated with a token wallet that is associated with the customer. If so, the server computing device may allow the customer to claim the $20 in merchant merchandise. Otherwise, the server computing device may indicate that the customer does not have authority to claim the $20 in merchant merchandise. The smart contract controlling the NFT may allow the customer to transfer the NFT enabling the customer to claim $20 in merchant merchandise to another customer for a $1 fee. The customer may request such a transfer and the server computing device may respond by deducting $1 from a payment method on file for the customer and transferring the NFT. The other customer may not be a customer at the time of the transfer of the new NFT. Instead, the customer may provide an email address or other communication address of the other customer and a token wallet associated with the email address may be created by the host platform 101 for the other customer. The new NFT may then be transferred to the token wallet and a notification may be sent to the other customer at the email address letting the other customer know that they can claim $19 in merchant merchandise. This improves user interfaces and the operation of computing devices associated with NFT transfer as the other customer does not have to know how to set up a token wallet and/or does not have to interact with one or more computing devices to do so. Various configurations are possible and contemplated without departing from the scope of the present disclosure.

In still other examples, an airline web site may use NFTs created via a host platform 101 as credentials for using frequent flier awards. As such, when a customer earns a frequent flier award, the airline web site may identify the customer's account, authenticate the customer by sending a one-time password to the customer's email address on file and then prompting for the password, creating a token wallet associated with the customer's email address (of which the customer may not be aware and to which the customer may not have access) using the host platform 101, and then create the NFT for the frequent flier award and associate it with the token wallet using the host platform 101. Subsequently, when the user looks up his frequent flier award status, the airline web site may access the token wallet and display award information for any NFTs in the token wallet.

The host platform 101 may include one or more frontends 104 and/or one or more backend services 105. The frontend 104 may include one or more application programming interfaces or “APIs”. Similarly, the backend services 105 may be accessed using one or more APIs. The frontend 104 may be usable by one or more issuer instances 102 to request creation of and/or performance of one or more transactions and/or other actions related to one or more NFTs 110, smart contracts 111, and/or minted documents 119. The frontend 104 may interact with one or more unsecure and/or secure storages 106 and/or one or more blockchains 107 to store one or more NFTs 110, smart contracts 111, minted documents 119, and so on. A directory service 108 may by usable by the host platform 101 to associate assets in the one more unsecure and/or secure storages 106 and/or one or more blockchains 107. The frontend 104 and/or the one or more blockchains 107 may be communicably connected to the backend services 105.

The issuer instance 102 may include one or more minters 112 that may include one or more user seats 113A-113N, a minting authority 114, an issuer 115, and so on. The issuer 115 may be verified and authenticated by the host platform 101, such as by communication over a verified connection, using multi-factor authentication (such as a login and/or password, a one-time password sent to a known email address and/or other communication address, one or more authenticator apps, and so on), and so on. The minting authority 114 and/or the issuer instance 102 may be communicably connected to the frontend 104.

The user platform 103 may include a user wallet 116 and a user 117. The user wallet 116 may be a token wallet. The user wallet 116 may store one or more private and/or public keys related to one or more NFTs. The user wallet 116 and/or the user platform 103 may be communicably connected to the one or more unsecure and/or secure storages 106, one or more blockchains 107, and/or backend services 105. The user 117 may be verified and authenticated by the host platform 101, such as by communication over a verified connection, using multi-factor authentication (such as a login and/or password, a one-time password sent to a known email address and/or other communication address, one or more authenticator apps, and so on), and so on.

FIG. 1B depicts a flow 130 of using creation and minting of a smart contract and non-fungible token. The flow may be performed by the system 100 of FIG. 1A. A what you see is what you get (“WYSIWYG”) and/or other user interface 131 may be provided. The user interface 131 may be used to author one or more smart contracts 132. The authored smart contracts may be validated 133 and/or optimized using artificial intelligence (AI) 134. The validated and/or optimized smart contract (and/or any generated related one or more NFTs) may be published to one or more blockchains 135. A digital asset related to the smart contract may be bound to the one or more NFTs and stored 136. The one or more NFTs may then be managed and the digital asset may be securely and/or otherwise stored 137.

Although the flow 130 illustrates a particular flow, it is understood that this is an example. In other implementations, other flows of the same, similar, and/or different operations may be used. Various configurations are possible and contemplated without departing from the scope of the present disclosure.

FIG. 1C depicts a list of backend services 105. The backend services 105 may support and/or be provided by the system 100 of FIG. 1A. The list may include one or more smart contract authors and/or optimizers, file directories, storage management, wallet managers, smart contract managers, NFT and FT managers, digital rights management (DRM), authenticators and/or verifiers, template managers, NFT and/or FT viewers, blockchain viewers, API gateways, AI optimizers, smart contract validators, blockchain bridges, cloud orchestration, account management, billing, analytics and/or telemetry tools, logging and operation tools, and so on.

Although the list illustrates examples of backend services 105, it is understood that this is an example. In other implementations, other backend services 105 may be used. Various configurations are possible and contemplated without departing from the scope of the present disclosure.

FIG. 1D depicts mint-print-manage functions 150. The mint-print-manage functions 150 may be performed and/or supported and/or provided by the system of FIG. 1A. As shown, a host platform may communicate with a user wallet 116 and/or a minting authority 114 to perform manage and print functions 151 and/or mint and print functions 152. The host platform 101 may use a backend 153 and/or an API layer 154 to store one or more NFTs 110 (which may include key unique elements of one or more documents 119, signature, and so on) in one or more blockchain 107 networks and/or one or more documents 119 (such as one or more contracts, licenses, and so on) in a distributed internet protocol file system storage and/or other unsecure and/or secure storage 106.

Although the mint-print-manage functions 150 are illustrated and described with a particular configuration, it is understood that this is an example. In other implementations, other configurations of the same, similar, and/or different operations may be used. Various configurations are possible and contemplated without departing from the scope of the present disclosure.

Returning to FIG. 1A, although the system 100 is illustrated and described as including particular components arranged in a particular configuration, it is understood that this is an example. In a number of implementations, various configurations of various components may be used without departing from the scope of the present disclosure.

For example, the system 100 is illustrated and described as the user platform 103 including the user wallet 116. However, it is understood that this is an example. In various implementations, the system 100 may include host platform 101 that automatically generates and/or maintains one or more local and/or cloud-based token wallets, such as token wallets associated with one or more communication addresses (such as one or more email addresses, telephone numbers, social media messaging addresses, and so on) of one or more users. This may increase the likelihood that users will use the system 100 as the users do not have to know how to create token wallets, as well as simplifying user interfaces and improving the operation of computing devices used to implement the system 100. Various configurations are possible and contemplated without departing from the scope of the present disclosure.

FIG. 2 depicts a flow chart illustrating a first example method 200 that involves automatic token wallet generation. This method may be performed by the system 100 of FIG. 1A.

At operation 210, an electronic device (such as one or more computing devices associated with the host platform 101 of FIG. 1A, the issuer instance 102 of FIG. 1A, the user platform 103 of FIG. 1A, and/or another device or system) may determine that an operation requires a token wallet. The operation may be a host platform operation, such as one or more of the operations discussed above with respect to the host platform 101 of FIG. 1A. The electronic device may determine that the operation requires a token wallet if the operation will create an NFT (which may require a token wallet to associate with the newly created NFT), transfer an NFT (which may require a token wallet to which to transfer the NFT), and so on.

At operation 220, the electronic device may generate a token wallet using an identifier. Generating the token wallet may generate the token wallet for a particular blockchain with which the operation is to be associated, such as generation of an NFT that will be stored on the particular blockchain. Generating the token wallet may include assigning the token wallet a storage and/or other address tied to one or more assets on the blockchain. Generation of the token wallet may include performing a variety of operations associated with generating and/or configuring a token wallet, such as generating a seed phrase. Generation of the token wallet may allocate a storage space in a non-transitory storage medium that is associated with the identifier and is usable for storing one or more private keys and/or other data associated with the token wallet. The identifier may be a unique identifier in that the identifier may uniquely identify a particular person or entity. For example, the unique identifier may be a person's frequent flier number, an account number, a checking account number, a savings account number, a social security number, a driver's license number, a state or federal identification number, a communication identifier (such as any identifier that may be used to communicate with the person, such as an email address, a telephone number, a social media account handle, and so on), a rewards number, and so on. The identifier may be specified in a request to perform the operation that is received by the electronic device. For example, the request may specify to create an NFT for the identifier.

At operation 230, the electronic device may use the token wallet to complete the operation. By way of illustration, if the operation is to create an NFT for the identifier, the electronic device may create the NFT and associate the created NFT with the token wallet generated using the identifier. By way of another illustration, if the operation is to transfer an NFT to a token wallet associated with the identifier, the electronic device may transfer the NFT to the token wallet generated using the identifier. Various configurations are possible and contemplated without departing from the scope of the present disclosure.

By way of example, the electronic device may receive a request from a bank to generate an NFT for a person associated with a bank account identifier. The request may specify that the token wallet is to be a dedicated token wallet hosted by a host platform (such as the host platform 101 of FIG. 1A). The token wallet may be dedicated in that the request may specify that NFTs from other requestors may not be associated with the token wallet. The electronic device may provide a hypertext markup language (“HTML”) plugin that the bank may include in their web site to enable interaction with the token wallet after creation. The person may not be notified regarding the creation of the token wallet. Instead, the bank web site may include one or more mechanisms (such as cookies stored on a computing device used by the person, a login and/or password, and so on) for verifying that the person is associated with the identifier. The bank may also associate the NFT with whatever rights the person has with respect to the bank web site and/or the bank account and/or other accounts. As such, verification that the person is associated with the identifier enables access to the NFT, and access to the NFT then enables the person to use whatever rights the person has with respect to the bank web site and/or the bank account and/or other accounts. In this way, the access control to whatever rights the person has with respect to the bank web site and/or the bank account and/or other accounts is maintained via the NFT and the bank does not have to control access to whatever rights the person has with respect to the bank web site and/or the bank account and/or other accounts and/or subject themselves to liability for such. Various configurations are possible and contemplated without departing from the scope of the present disclosure.

Alternatively, instead of a dedicated token wallet hosted by a host platform, other token wallets may be used. By way of illustration, the token wallet may be a generic token wallet that NFTs from other requestors may be stored in. By way of another illustration, the token wallet may be a sub wallet of a generic token wallet that is “branded” for the requestor by being configured according to specifications (such as regarding what NFTs and/or other information appears, information to display regarding the requestor, elements providing the appearance that the token wallet is provided by the requestor and/or part of the requestor's web site and/or other system, and so on). By way of yet another illustration, the token wallet may be a branded token wallet that is not a sub wallet, a shared wallet that is included within a master wallet, a third party token wallet, and so on. Various configurations are possible and contemplated without departing from the scope of the present disclosure.

By way of another example, the electronic device may receive a request from a first person associated with a first frequent flyer number to transfer an NFT associated with a frequent flyer award to a second person associated with a second frequent flyer number. The electronic device may respond by generating a token wallet for the second person and transferring the NFT from a token wallet associated with the first person to the newly generated token wallet. In this way, the first person may be able to transfer the NFT without first having the second person set up the token wallet. Further, the airline associated with the frequent flyer number may not have to maintain a database and/or other system for tracking frequent flyer awards and/or subject themselves to liability for such. Various configurations are possible and contemplated without departing from the scope of the present disclosure.

In various examples, this example method 200 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 200 is illustrated and described as including particular operations performed in a particular order, it is understood that this is an example. In various implementations, various orders of the same, similar, and/or different operations may be performed without departing from the scope of the present disclosure.

For example, the method 200 is illustrated and described as determining that an operation requires a token wallet and generating the token wallet using the identifier. However, it is understood that this is an example. In various implementations, the electronic device may determine that a token wallet (such as a token wallet associated with the identifier) already exists. In such an example, the electronic device may use the already existing token wallet rather than generating a new token wallet. Various configurations are possible and contemplated without departing from the scope of the present disclosure.

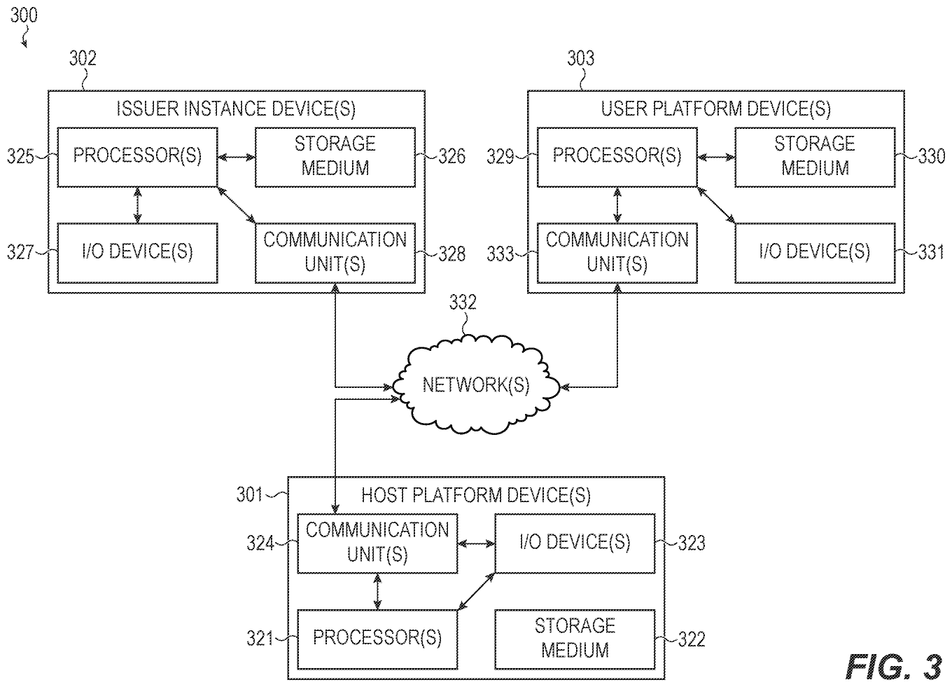

FIG. 3 depicts example relationships 300 among example components that may be used to implement the system 100 of FIG. 1A.

The host platform 101 of FIG. 1 may be implemented using one or more host platform devices 301. The host platform device 301 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The host platform device 301 may include one or more processors 321 and/or other processing units and/or controllers, one or more non-transitory storage media 322 (which may take the form of, but is not limited to, a magnetic storage medium; optical storage medium; magneto-optical storage medium; read only memory; random access memory; erasable programmable memory; flash memory; and so on), one or more communication units 324 (such as one or more network adapters and/or other devices used by a device to communicate with one or more other devices), one or more input and/or output components 323 (such as one or more displays, speakers, touch screens, computer mice, track pads, keyboards, printers, and so on) and/or one or more other components. The processor 321 may execute instructions stored in the non-transitory storage medium 322 to perform various functions. Such functions may include any of the functions discussed herein with respect to the host platform 101 of FIG. 1A; communicating with one or more issuer instance devices 302, user platform devices 303, and/or one or more other devices via one or more wired and/or wireless networks 332; and so on. Alternatively and/or additionally, the host platform device 301 may involve one or more memory allocations configured to store at least one executable asset and one or more processor allocations configured to access the one or more memory allocations and execute the at least one executable asset to instantiate one or more processes and/or services, such as one or more host platform services, and so on.

Similarly, the issuer instance 102 of FIG. 1A may be implemented using one or more issuer instance devices 302. The issuer instance device 302 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The issuer instance device 302 may include one or more processors 325 and/or other processing units and/or controllers, one or more non-transitory storage media 326 (which may take the form of, but is not limited to, a magnetic storage medium; optical storage medium; magneto-optical storage medium; read only memory; random access memory; erasable programmable memory; flash memory; and so on), one or more communication units 328 (such as one or more network adapters and/or other devices used by a device to communicate with one or more other devices), one or more input and/or output components 327 (such as one or more displays, speakers, touch screens, computer mice, track pads, keyboards, printers, and so on) and/or one or more other components. The processor 325 may execute instructions stored in the non-transitory storage medium 326 to perform various functions. Such functions may include any of the functions discussed herein with respect to the issuer instance 102 of FIG. 1A; communicating with one or more host platform devices 301, user platform devices 303, and/or one or more other devices via one or more wired and/or wireless networks 332; and so on. Alternatively and/or additionally, the issuer instance device 302 may involve one or more memory allocations configured to store at least one executable asset and one or more processor allocations configured to access the one or more memory allocations and execute the at least one executable asset to instantiate one or more processes and/or services, such as one or more issuer instance services, and so on.

Likewise, the user platform 103 of FIG. 1A may be implemented using one or more user platform devices 303. The user platform device 303 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The user platform device 303 may include one or more processors 329 and/or other processing units and/or controllers, one or more non-transitory storage media 330 (which may take the form of, but is not limited to, a magnetic storage medium; optical storage medium; magneto-optical storage medium; read only memory; random access memory; erasable programmable memory; flash memory; and so on), one or more communication units 333 (such as one or more network adapters and/or other devices used by a device to communicate with one or more other devices), one or more input and/or output components 331 (such as one or more displays, speakers, touch screens, computer mice, track pads, keyboards, printers, and so on) and/or one or more other components. The processor 329 may execute instructions stored in the non-transitory storage medium 330 to perform various functions. Such functions may include any of the functions discussed herein with respect to the user platform 103 of FIG. 1A; communicating with one or more issuer instance devices 302, host platform devices 301, and/or one or more other devices via one or more wired and/or wireless networks 332; and so on. Alternatively and/or additionally, the user platform device 303 may involve one or more memory allocations configured to store at least one executable asset and one or more processor allocations configured to access the one or more memory allocations and execute the at least one executable asset to instantiate one or more processes and/or services, such as one or more user platform services, and so on.

Additionally, FIG. 1A may involve one or more other devices not shown. Such other devices may be any kind of electronic device. Examples of such other devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The other devices may include one or more processors and/or other processing units and/or controllers, one or more non-transitory storage media (which may take the form of, but is not limited to, a magnetic storage medium; optical storage medium; magneto-optical storage medium; read only memory; random access memory; erasable programmable memory; flash memory; and so on), one or more communication units (such as one or more network adapters and/or other devices used by a device to communicate with one or more other devices), one or more input and/or output components (such as one or more displays, speakers, touch screens, computer mice, track pads, keyboards, printers, and so on) and/or one or more other components. The processor may execute instructions stored in the non-transitory storage medium to perform various functions. Such functions may include any of the functions discussed herein; communicating with one or more issuer instance devices 302, user platform devices 303, host platform devices 301, and/or one or more other devices via one or more wired and/or wireless networks 332; and so on. Alternatively and/or additionally, the other devices may involve one or more memory allocations configured to store at least one executable asset and one or more processor allocations configured to access the one or more memory allocations and execute the at least one executable asset to instantiate one or more processes and/or services, such as one or more other device services, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices and systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first- or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

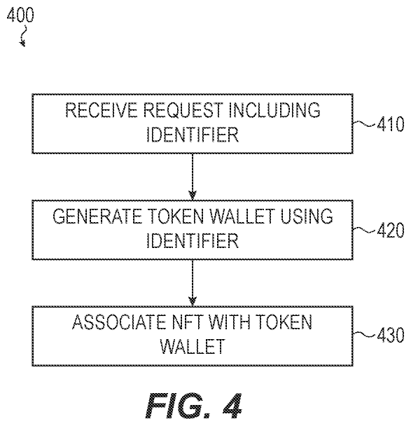

FIG. 4 depicts a flow chart illustrating a second example method 400 that involves automatic token wallet generation. This method 400 may be performed by the system 100 of FIG. 1A.

At operation 410, an electronic device (such as one or more computing devices associated with the host platform 101 of FIG. 1A, the issuer instance 102 of FIG. 1A, the user platform 103 of FIG. 1A, and/or another device or system) may receive a request including an identifier. The identifier may be a unique identifier for a person, may be a communication identifier, and so on. The request may be to associate an NFT with a token wallet associated with the identifier.

At operation 420, the electronic device may generate a token wallet using the identifier. The token wallet may be a dedicated token wallet for the requestor, a branded token wallet configured according to requestor specifications, a generic token wallet hosted by a host platform (such as the host platform 101 of FIG. 1A), a sub wallet of a master wallet, and so on. Generation of the token wallet may include associating the token wallet with the identifier.

At operation 430, the electronic device may associate the NFT with the token wallet. Associating the NFT with the token wallet may include updating a blockchain associated with the NFT to indicate that the NFT is associated with the token wallet, storing one or more private keys and/or other items associated with the NFT in the token wallet, and so on.

By way of example, an issuer of a digital birth certificate NFT may submit an electronic device that specifies a social security number for the person. The request may be to associate the digital birth certificate NFT with a token wallet associated with the social security number for the person. The electronic device may generate a token wallet associated with the social security number for the person and associate the digital birth certificate NFT for the person with the token wallet. Various configurations are possible and contemplated without departing from the scope of the present disclosure.

In various examples, this example method 400 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 illustrates and describes generating a token wallet using the identifier. However, it is understood that this is an example. In various examples, the electronic device may generate a sub wallet in an already existing master wallet associated with the person. The electronic device may then associate the NFT with the sub wallet instead of a newly generated token wallet. Various configurations are possible and contemplated without departing from the scope of the present disclosure.

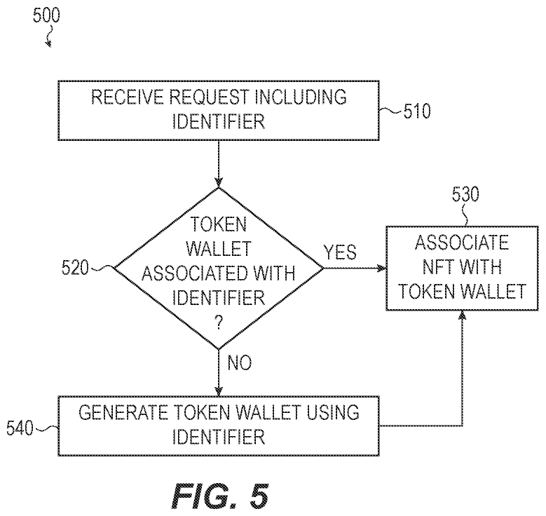

FIG. 5 depicts a flow chart illustrating a third example method 500 that involves automatic token wallet generation. This method 500 may be performed by the system 100 of FIG. 1A.

At operation 510, an electronic device (such as one or more computing devices associated with the host platform 101 of FIG. 1A, the issuer instance 102 of FIG. 1A, the user platform 103 of FIG. 1A, and/or another device or system) may receive a request including an identifier. The request may specify to associate an NFT with a token wallet associated with the identifier, transfer an NFT to a token wallet associated with the identifier, and so on. At operation 520, the electronic device may determine whether or not a token wallet is associated with identifier.

If so, the flow may proceed to operation 530 where the electronic device may associate the NFT with the token wallet. Otherwise, the flow may proceed to operation 540 where the electronic device may generate a token wallet using the identifier before the flow proceeds to operation 530 where the electronic device may associate the NFT with the token wallet.

For example, the electronic device may receive a request from a streaming media or other service to associate an authorization NFT with a token wallet associated with an email address. The electronic device may determine that a token wallet has already been created that is associated with the email address, which may have been created to store a data access NFT requested by a tax preparation service. The electronic device may then associate the authorization NFT with the token wallet. In some implementations, the electronic device may create a sub wallet within the token wallet and associate the authorization NFT with the sub wallet. Various configurations are possible and contemplated without departing from the scope of the present disclosure.

In various examples, this example method 500 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 500 is illustrated and described as including particular operations performed in a particular order, it is understood that this is an example. In various implementations, various orders of the same, similar, and/or different operations may be performed without departing from the scope of the present disclosure.

For example, the method 500 illustrates and describes the electronic device generating the token wallet. However, it is understood that this is an example. In various examples, the electronic device may instead request another device to generate the token wallet. Various configurations are possible and contemplated without departing from the scope of the present disclosure.

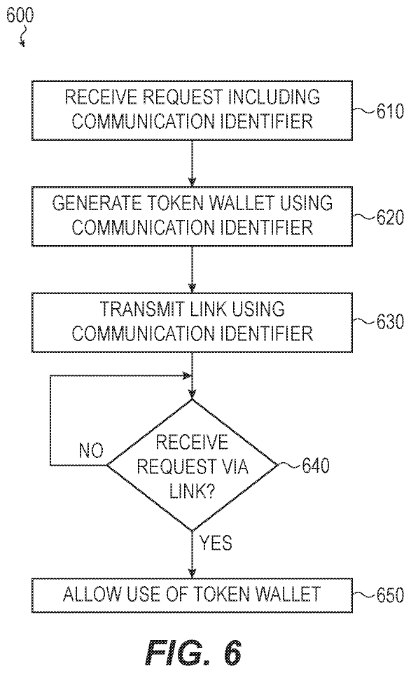

FIG. 6 depicts a flow chart illustrating a fourth example method 600 that involves automatic token wallet generation. This method 600 may be performed by the system 100 of FIG. 1A.

At operation 610, an electronic device (such as one or more computing devices associated with the host platform 101 of FIG. 1A, the issuer instance 102 of FIG. 1A, the user platform 103 of FIG. 1A, and/or another device or system) may receive a request including a communication identifier. The communication identifier may be any identifier that may be used to communicate with a person, such as an email address, a telephone number, a social media handle, and so on. The request may involve one or more operations that include generation of a token wallet.

At operation 620, the electronic device may generate a token wallet using the communication identifier. The electronic device may allocate a storage space for the token wallet in a non-transitory storage medium of a host platform (such as the host platform 101 of FIG. 1A) and associate the storage space with the communication identifier.

At operation 630, the electronic device may transmit a link using the communication identifier. The link may be a link that is usable to access the token wallet. For example, the communication identifier may be an email address and the electronic device may email the link to the email address.

At operation 640, the electronic device may determine whether or not a request is received via the link. For example, in the above illustration where the communication identifier is an email address and the electronic device emails the link to the email address, the request may be received if a person associated with the email address opens the email and clicks on the link. If not, the flow may return to operation 640 where the electronic device may again determine whether or not a request is received via the link. Otherwise, the flow may proceed to operation 650.

At operation 650, the electronic device may allow use of the token wallet. Use of the token wallet may include viewing information related to one or more NFTs associated with the token wallet, using one or more NFTs associated with the token wallet, transferring one or more NFTs associated with the token wallet, and so on.

For example, a person may use an invitation service to send an invitation to a person's phone number. The invitation service may accordingly transmit a request to the electronic device to generate an invitation NFT (which may include an image detailing the invitation, act as proof to enter the invited area at the invited time, and so on) and associate it with a token wallet associated with the person's phone number. The electronic device may then generate the invitation NFT and the token wallet, associate the invitation NFT with the token wallet, text a link to the token wallet to the person, and allow use of the invitation NFT in the token wallet when a request is received via the link. Various configurations are possible and contemplated without departing

In various examples, this example method 600 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 illustrates and describes allowing use of the token wallet if a request is received via the link transmitted to the communication identifier. However, it is understood that this is an example. In various examples, other security mechanisms (such as one or more one time passwords) may be used in addition to determining whether or not a request is received via the link transmitted to the communication identifier. Various configurations are possible and contemplated without departing from the scope of the present disclosure.

Various configurations are possible and contemplated without departing from the scope of the present disclosure.

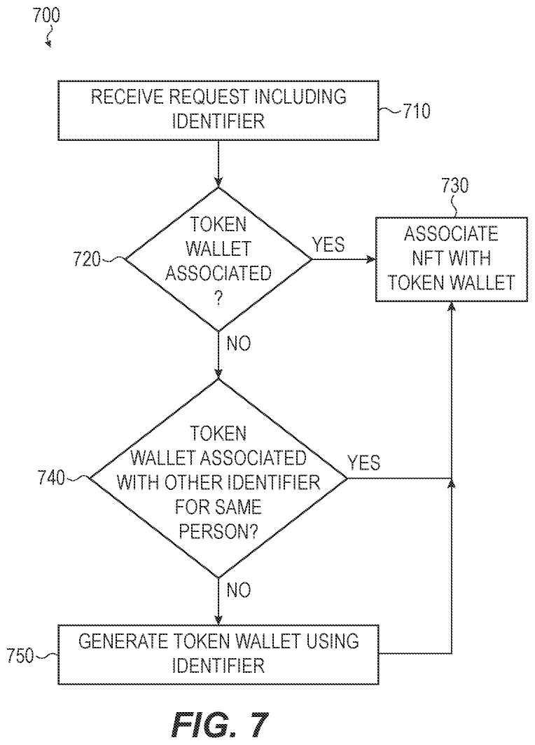

FIG. 7 depicts a flow chart illustrating a fifth example method 700 that involves automatic token wallet generation. This method 700 may be performed by the system 100 of FIG. 1A.

At operation 710, an electronic device (such as one or more computing devices associated with the host platform 101 of FIG. 1A, the issuer instance 102 of FIG. 1A, the user platform 103 of FIG. 1A, and/or another device or system) may receive a request including an identifier. For example, the request may be to generate an NFT and associate it with a token wallet associated with the identifier.

At operation 720, the electronic device may determine whether or not a token wallet is associated with the identifier. For example, the electronic device may search a list of token wallets and their associated identifiers to determine whether or not a token wallet already exists that is associated with the identifier. If so, the flow may proceed to operation 730 where the electronic device may associate the NFT with the token wallet. Otherwise, the flow may proceed to operation 740.

At operation 740, the electronic device may determine whether or not a token wallet is associated with another identifier a for same person. For example, token wallets may be associated with email addresses, but a person may have more than one email address. The request may specify a first email address for a person that is not associated with a token wallet, but a token wallet may already exist that is associated with a second email address for the person. Other information associated with the token wallet may be used to determine whether or not a token wallet is associated with another identifier for a same person. For example, the request may also indicate a telephone number, a full name, a home address, and so on. Such information may also be associated with an existing token wallet. If so, the electronic device may determine that a token wallet is associated with another identifier for a same person even though it is not associated with the requested identifier. If so, the flow may proceed to operation 730 where the electronic device may associate the NFT with the token wallet. Otherwise, the flow may proceed to operation 750.

At operation 750, the electronic device may generate a token wallet using the identifier. The flow may then proceed to operation 730 where the electronic device may associate the NFT with the token wallet.

For example, the electronic device may receive a request to generate a rewards program NFT and associate it with a token wallet for a person living at 710 Alameda Street named Frank M. Jones who has a landline telephone number 555-555-1981. The electronic device may determine that there is no token wallet associated with the landline telephone number 555-555-1981. However, the electronic device may determine that a token wallet previously generated for an airline frequent flyer program has a home address listed of 710 Alameda Street and a name of Frank M. Jones, but is associated with a cellular telephone number 555-555-2002. The electronic device may determine that Frank M. Jones is the same person, generate the rewards program NFT, and associate the rewards program NFT with the previously generated token wallet. Various configurations are possible and contemplated without departing from the scope of the present disclosure.

In various examples, this example method 700 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 illustrates and describes operations 720 and 740 as separate operations. However, it is understood that this is an example. In various examples, operations 720 and 740 may be combined into a single operation. Various configurations are possible and contemplated without departing from the scope of the present disclosure.

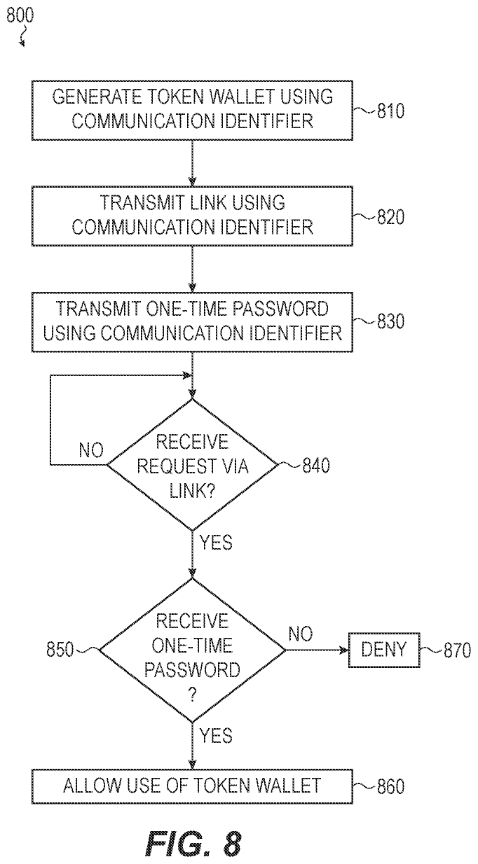

FIG. 8 depicts a flow chart illustrating a sixth example method 800 that involves automatic token wallet generation. This method 800 may be performed by the system 100 of FIG. 1A.

At operation 810, an electronic device (such as one or more computing devices associated with the host platform 101 of FIG. 1A, the issuer instance 102 of FIG. 1A, the user platform 103 of FIG. 1A, and/or another device or system) may generate a token wallet using a communication identifier. The communication identifier may be an email address, a telephone number, a social media handle, and/or any other unique identifier that may be used to communicate with a person.

At operation 820, the electronic device may transmit a link using the communication identifier. For example, the electronic device may transmit a link in a social media message using the person's social media handle.

At operation 830, the electronic device may transmit a one-time password using the communication identifier. For example, the electronic device may transmit the one-time password in a social media message using the person's social media handle. However, it is understood that this is an example. In other examples, other security mechanisms may be used other than one-time passwords. Further, in other examples, the one-time password may be transmitted in the same communication as the link. Various configurations are possible and contemplated without departing from the scope of the present disclosure.

At operation 840, the electronic device may determine whether or not a request via the link is received. If not, the flow may return to operation 840 where the electronic device may again determine whether or not a request via the link is received. Otherwise, the flow may proceed to operation 850.

At operation 850, the electronic device may determine whether or not the one-time password is received. For example, receipt of a request via the link may cause the electronic device to prompt for the one-time password. The one-time password may then be received in response to the prompt. If so, the flow may proceed to operation 860 where the electronic device may allow use of the token wallet. Otherwise, the flow may proceed to operation 870 where the electronic device may deny use of the token wallet.

For example, a grocery store may request that an electronic device transmit a coupon NFT associated with a product discount to an email address. The electronic device may generate the coupon NFT, generate a token wallet using the email address, associate the coupon NFT, and transmit a link and a one-time password to the email address. Upon receiving a request via the link and the one-time password, the electronic device may allow access to the token wallet with the associated coupon NFT. Various configurations are possible and contemplated without departing from the scope of the present disclosure.

In various examples, this example method 800 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 800 is illustrated and described as including particular operations performed in a particular order, it is understood that this is an example. In various implementations, various orders of the same, similar, and/or different operations may be performed without departing from the scope of the present disclosure.

For example, the method 800 illustrates and describes transmitting a link using the communication identifier. However, it is understood that this is an example. In various examples, the mechanism for accessing the token wallet transmitted using the communication identifier may be other than a link. Various configurations are possible and contemplated without departing from the scope of the present disclosure.

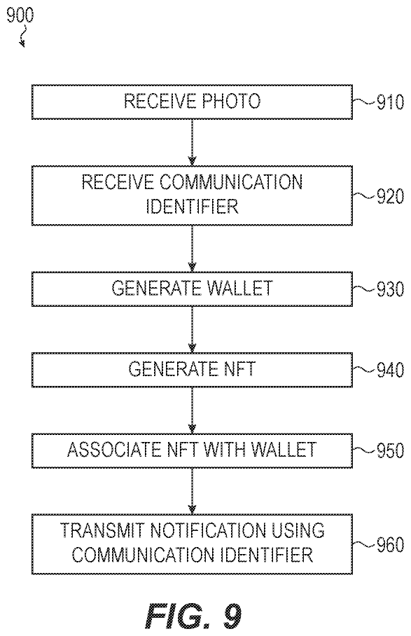

FIG. 9 depicts a flow chart illustrating a seventh example method 900 that involves automatic token wallet generation. This method 900 may be performed by the system 100 of FIG. 1A.

At operation 910, an electronic device (such as one or more computing devices associated with the host platform 101 of FIG. 1A, the issuer instance 102 of FIG. 1A, the user platform 103 of FIG. 1A, and/or another device or system) may receive a photo. At operation 920, the electronic device may receive a communication identifier. For example, an app and/or other application on a smart phone may be usable to take a digital photo and submit such to the electronic device, specifying a communication identifier, in order to generate an NFT for the photo and make such available via the communication identifier.

At operation 930, the electronic device may generate a token wallet associated with the communication identifier. At operation 940, the electronic device may generate the NFT for the photo. In some examples, the NFT may include an image of the photo. In various examples, the photo may be stored on a blockchain and the NFT may enable access to the image, alteration of the image, and so on (whether indefinitely as specified in an associated smart contract, for a period of time as specified in the smart contract, under specified conditions as specified in the smart contract, and so on).

At operation 950, the electronic device may associate the NFT with the token wallet. At operation 960, the electronic device may transmit a notification regarding the NFT using the communication identifier. The notification may include a link to access the token wallet, the NFT, the photo, and so on.

In various examples, this example method 900 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 900 is illustrated and described as including particular operations performed in a particular order, it is understood that this is an example. In various implementations, various orders of the same, similar, and/or different operations may be performed without departing from the scope of the present disclosure.

For example, the method 900 illustrates and describes receiving the photo and generating the NFT. However, it is understood that this is an example. In various implementations, the electronic device may receive the NFT instead of receiving the photo and generating the NFT. Various configurations are possible and contemplated without departing from the scope of the present disclosure.

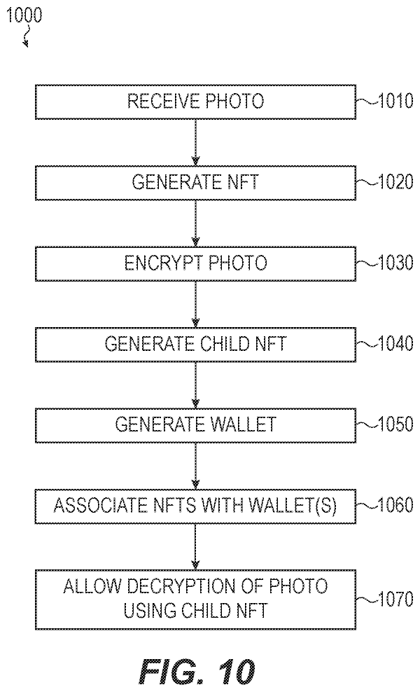

FIG. 10 depicts a flow chart illustrating an eighth example method 1000 that involves automatic token wallet generation. This method 1000 may be performed by the system 100 of FIG. 1A.

At operation 1010, an electronic device (such as one or more computing devices associated with the host platform 101 of FIG. 1A, the issuer instance 102 of FIG. 1A, the user platform 103 of FIG. 1A, and/or another device or system) may receive a photo. At operation 1020, the electronic device may generate an NFT. The NFT may allow full control over the photo.

At operation 1030, the electronic device may encrypt the photo. At operation 1040, the electronic device may generate a child NFT. The child NFT may enable decryption and/or other access to the photo, but may not allow the full control over the photo that is allowed by the NFT.

At operation 1050, the electronic device may generate a token wallet. The electronic device may associate the token wallet with a communication identifier. At operation 1060, the electronic device may associate the NFTs with the token wallet and/or one or more other token wallets. At operation 1070, the electronic device may allow decryption of the photo using the child NFT.

For example, an app and/or other application on a smart phone may be usable to take a digital photo and submit such to the electronic device, specifying a communication identifier. The electronic device may generate an NFT for the photo, encrypt the photo, generate a child NFT, generate a token wallet for the communication identifier, associate the child NFT with the token wallet, associate the NFT with a token wallet associated with the requestor, and then allow decryption of the photo using the child NFT. In this way a user may be able to use the app and/or other application on a smart phone to take digital photos, make such available in an encrypted fashion via a blockchain, retain full control of the photo, and share access to the photo with others without enabling the others to have full control. Various configurations are possible and contemplated without departing from the scope of the present disclosure.

In various examples, this example method 1000 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1000 is illustrated and described as including particular operations performed in a particular order, it is understood that this is an example. In various implementations, various orders of the same, similar, and/or different operations may be performed without departing from the scope of the present disclosure.

For example, the method 1000 illustrates and describes generating a child NFT that allows decryption of the photo. However, it is understood that this is an example. In various examples, generation of the child NFT may be omitted and the NFT may be used to decrypt the photo. Various configurations are possible and contemplated without departing from the scope of the present disclosure.

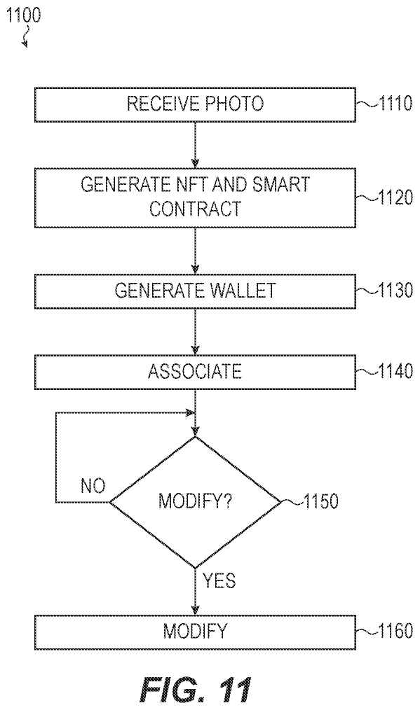

FIG. 11 depicts a flow chart illustrating a ninth example method 1100 that involves automatic token wallet generation. This method 1100 may be performed by the system 100 of FIG. 1A.

At operation 1110, an electronic device (such as one or more computing devices associated with the host platform 101 of FIG. 1A, the issuer instance 102 of FIG. 1A, the user platform 103 of FIG. 1A, and/or another device or system) may receive a photo. The electronic device may also receive a communication identifier.

At operation 1120, the electronic device may generate an NFT and associated smart contract for the photo. The NFT may allow modification of the photo as specified in the associated smart contract.

At operation 1130, the electronic device may generate a token wallet. The electronic device may associate the token wallet with the communication identifier. At operation 1140, the electronic device may associate the NFT with the token wallet.

At operation 1150, the electronic device may determine whether or not an authorized request to modify the photo is received. By way of example, the request may be authorized when made by a person associated with the token wallet. The authorized request to modify the photo may include removing one or more watermarks, decrypting the photo, removing red eye, cropping, adjusting brightness, image enhancement, and so on. If not, the flow may return to operation 1150 where the electronic device again may determine whether or not an authorized request to modify the photo is received. Otherwise, the flow may proceed to operation 1160 where the electronic device may modify the photo as per the authorized request.

For example, a user may use the method 1100 to provide watermarked photos on a blockchain and use the NFT to enable paid users to remove the watermark. By way of another example, a user may use the method 1100 to provide non-editable versions of photos on a blockchain and use the NFT to enable paid users to access editable versions of the photos. Various configurations are possible and contemplated without departing from the scope of the present disclosure.

In various examples, this example method 1100 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1100 is illustrated and described as including particular operations performed in a particular order, it is understood that this is an example. In various implementations, various orders of the same, similar, and/or different operations may be performed without departing from the scope of the present disclosure.

For example, the method 1100 illustrates and describes determining whether or not to modify the photo. However, it is understood that this is an example. In various examples, the determination may be made whether or not to allow access to the photo, allow access to a higher resolution version of the photo, allow copying of the photo, and/or other operations involving the photo. Various configurations are possible and contemplated without departing from the scope of the present disclosure.

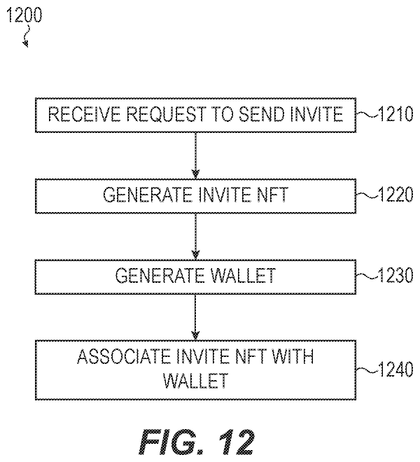

FIG. 12 depicts a flow chart illustrating a tenth example method 1200 that involves automatic token wallet generation. This method 1200 may be performed by the system 100 of FIG. 1A.

At operation 1210, an electronic device (such as one or more computing devices associated with the host platform 101 of FIG. 1A, the issuer instance 102 of FIG. 1A, the user platform 103 of FIG. 1A, and/or another device or system) may receive a request to send an invite. The invite may be an invitation to a birthday party, housewarming party, ticketed event, and/or any other event to which someone may be invited.

At operation 1220, the electronic device may generate an invite NFT. At operation 1230, the electronic device may generate a token wallet with which to associate the NFT. For example, the electronic device may generate the token wallet using a provided communication identifier. At operation 1240, the electronic device may associate the invite NFT with the generated token wallet.

For example, a sport venue may request creation of invite NFTs for a season ticket holder appreciation night. The request may specify to have the invite NFTs respectively associated with token wallets generated using email addresses for each of the season ticket holders of the sport venue. Various configurations are possible and contemplated without departing from the scope of the present disclosure.

In various examples, this example method 1200 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1200 is illustrated and described as including particular operations performed in a particular order, it is understood that this is an example. In various implementations, various orders of the same, similar, and/or different operations may be performed without departing from the scope of the present disclosure.

For example, the method 1200 illustrates and describes generating invite NFTs. However, it is understood that this is an example. In various examples, the NFTs may be for other purposes than an invite, such as one or more requested tickets, one or more coupons, one or more loyalty reward program rewards, and so on. Various configurations are possible and contemplated without departing from the scope of the present disclosure.

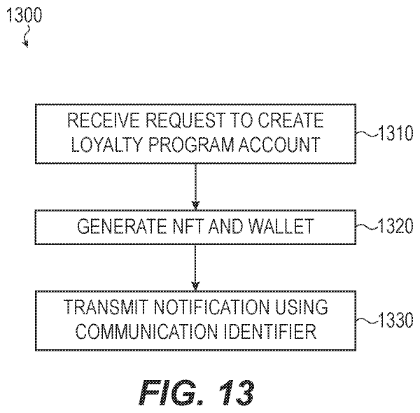

FIG. 13 depicts a flow chart illustrating an eleventh example method 1300 that involves automatic token wallet generation. This method 1300 may be performed by the system 100 of FIG. 1A.

At operation 1310, an electronic device (such as one or more computing devices associated with the host platform 101 of FIG. 1A, the issuer instance 102 of FIG. 1A, the user platform 103 of FIG. 1A, and/or another device or system) may receive a request to create a loyalty program account.

At operation 1320, the electronic device may generate an NFT for the loyalty program account and a token wallet with which to associate the NFT. The token wallet may be generated using a communication identifier associated with the loyalty program account. The NFT may enable access to the loyalty program account and loyalty program account progress and/or rewards may be tracked on a blockchain associated with the NFT instead of being stored in a database maintained by the requestor.

At operation 1330, the electronic device may transmit a notification using the communication identifier. For example, the communication identifier may be a phone number and the electronic device may call the phone number with a recorded message regarding how to access the token wallet. The notification may include one or more access credentials that are usable to access the token wallet, such as a login and password, an access token, a one-time password, and so on.

For example, a tire store may request that a loyalty program account be created for a customer. The loyalty program account may be associated with an email address for the customer. The electronic device may generate an NFT for the customer's loyalty program account and a token wallet associated with the customer's email address with which to associate the NFT. The NFT may enable the customer to access the loyalty program account and the customer's loyalty program account progress and/or rewards may be tracked on a blockchain associated the NFT instead of being stored in a database maintained by the requestor. The electronic device may then transmit a notification about the loyalty program account, the NFT, and/or the token wallet to the customer via the customer's email address. Various configurations are possible and contemplated without departing from the scope of the present disclosure.

In various examples, this example method 1300 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1300 is illustrated and described as including particular operations performed in a particular order, it is understood that this is an example. In various implementations, various orders of the same, similar, and/or different operations may be performed without departing from the scope of the present disclosure.

For example, the method 1300 illustrates and describes transmitting a notification using the communication identifier. However, it is understood that this is an example. In various implementations, this operation may be omitted. Various configurations are possible and contemplated without departing from the scope of the present disclosure.

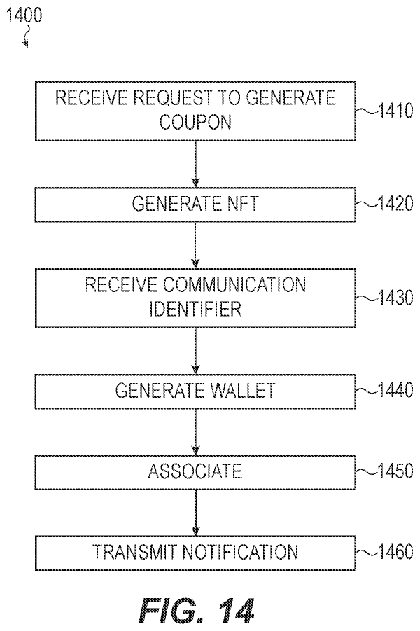

FIG. 14 depicts a flow chart illustrating a twelfth example method 1400 that involves automatic token wallet generation. This method 1400 may be performed by the system 100 of FIG. 1A.

At operation 1410, an electronic device (such as one or more computing devices associated with the host platform 101 of FIG. 1A, the issuer instance 102 of FIG. 1A, the user platform 103 of FIG. 1A, and/or another device or system) may receive a request to generate a coupon. The coupon may be redeemable for discounted goods and/or services, free goods and/or services, free and/or discounted entry into an event, and so on.

At operation 1420, the electronic device may generate an NFT. The NFT may be redeemable for the discounted goods and/or services, free goods and/or services, free and/or discounted entry into an event, and so on associated with the coupon. In some examples, the NFT may include an image of the coupon, such as a quick response code and/or other bar code scannable to redeem the coupon.

At operation 1430, the electronic device may receive a communication identifier. The communication identifier may be received from the same source as the request to generate the coupon.

At operation 1440, the electronic device may generate a token wallet. The electronic device may associate the token wallet with the communication identifier. At operation 1450, the electronic device may associate the NFT with the token wallet.

At operation 1460, the electronic device may transmit a notification associated with the coupon, the NFT, the token wallet, and so on. The notification may be transmitted to the communication identifier.

For example, a coffee shop may request creation of a coupon for a free small coffee. The electronic device may generate an NFT for the coupon. The electronic device may then receive an app ID for a coffee shop app executing on a coffee shop customer's smart phone. The electronic device may generate a token wallet associated with the app ID, associate the NFT with the token wallet, and transmit a notification to the coffee shop app executing on the coffee shop customer's smart phone (such as via one or more server computing devices, cloud computing devices, and/or other computing devices associated with the coffee shop app executing on the coffee shop customer's smart phone) regarding the coupon. Various configurations are possible and contemplated without departing from the scope of the present disclosure.

By way of another example, a restaurant may request creation of a coupon for a free dinner with the purchase of another dinner of equal or lesser value. The electronic device may generate an NFT for the coupon. The electronic device may then receive an email address for a person that the restaurant would like to visit the restaurant. The electronic device may generate a token wallet associated with the email address, associate the NFT with the token wallet, and transmit a notification to the email address regarding the coupon. Various configurations are possible and contemplated without departing from the scope of the present disclosure.

In various examples, this example method 1400 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1400 is illustrated and described as including particular operations performed in a particular order, it is understood that this is an example. In various implementations, various orders of the same, similar, and/or different operations may be performed without departing from the scope of the present disclosure.

For example, the method 1400 illustrates and describes transmitting the notification. However, it is understood that this is an example. In various examples, this operation may be performed by the requestor instead of the electronic device after the NFT is associated with the token wallet. Various configurations are possible and contemplated without departing from the scope of the present disclosure.

In various implementations, a system may include a non-transitory storage medium storing instructions and a processor. The processor may execute the instructions to receive a request to provide a non-fungible token (NFT) to a person associated with a unique identifier, generate a token wallet, associate the token wallet with the unique identifier, create the NFT, and associate the NFT with the token wallet.

In some examples, the processor may provide access to the token wallet via a hypertext markup language plugin. In a number of examples, the token wallet may include sub wallets. In various such examples, one of the sub wallets may be a branded sub wallet.

In a number of examples, the unique identifier may be a communication identifier. In some such examples, the communication identifier may be at least one of an email address, a telephone number, or a social media account identifier. In various such examples, the processor may transmit a notification regarding the token wallet to the communication identifier, transmit a one-time password to the communication identifier, and allow access to the token wallet upon being provided with the one-time password.

In some implementations, a system may include a non-transitory storage medium storing instructions and a processor. The processor may execute the instructions to determine that an operation requires a token wallet associated with a unique identifier, determine that the token wallet does not already exist, generate the token wallet, and associate a non-fungible token (NFT) with the token wallet.

In various examples, the operation may be a first operation, the unique identifier may be a first unique identifier, the token wallet may be a first token wallet and the processor may determine that a second operation requires a second token wallet associated with a second unique identifier, identify that a third token wallet associated with a third unique identifier is associated with a same person as the second unique identifier, and use the third token wallet instead of generating the second token wallet. In a number of such examples, the processor may use the third token wallet by creating a sub wallet in the third token wallet for the second operation. In various such examples, the processor may identify that the third token wallet associated with the third unique identifier is associated with a same person as the second unique identifier by determining that a same phone number is associated with both the third unique identifier and the second unique identifier.

In some examples, the unique identifier may be a frequent flyer number. In a number of examples, association of the NFT with the token wallet may be usable in place of an access credential to access a computing device associated with a requestor of the operation. In some examples, the operation may be generation of the NFT.

In a number of implementations, a system may include a non-transitory storage medium storing instructions and a processor. The processor may execute the instructions to receive a digital photograph to send to a person associated with a unique identifier, create a non-fungible token (NFT) and an associated smart contract relating to accessing the digital photograph, generate a token wallet that is associated with the unique identifier, and associate the NFT with the token wallet.

In some examples, the processor may generate an access protected version of the digital photograph. In various such examples, the processor may store the access protected version of the digital photograph on a blockchain. In a number of such examples, the processor may generate the access protected version of the digital photograph by encrypting the digital photograph and the NFT may be usable to decrypt an encrypted version of the digital photograph. In some such examples, the processor may generate the access protected version of the digital photograph by encrypting the digital photograph.

In various examples, the associated smart contract may be operable to render the digital photograph no longer accessible.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to automatic token wallet generation. A token wallet is generated for a unique identifier that is associated with a person, which may be a communication identifier like an email address, a telephone number, a social media handle, and so on. Storage space may be allocated for the token wallet and may be associated with the unique identifier. One or more NFTs may then be associated with the token wallet.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system, comprising:
a non-transitory storage medium storing instructions; and
a processor that executes the instructions to:
receive a request to provide a non-fungible token (NFT) to a person associated with a unique identifier;
generate a token wallet;
associate the token wallet with the unique identifier;
create the NFT; and
associate the NFT with the token wallet.

2. The system of claim 1, wherein the processor provides access to the token wallet via a hypertext markup language plugin.

3. The system of claim 1, wherein the token wallet includes sub wallets.

4. The system of claim 3, wherein one of the sub wallets is a branded sub wallet.

5. The system of claim 1, wherein the unique identifier is a communication identifier.

6. The system of claim 5, wherein the communication identifier is at least one of an email address, a telephone number, or a social media account identifier.

7. The system of claim 5, wherein the processor:
transmits a notification regarding the token wallet to the communication identifier;
transmits a one-time password to the communication identifier; and
allows access to the token wallet upon being provided with the one-time password.

8. A system, comprising:
a non-transitory storage medium storing instructions; and
a processor that executes the instructions to:
determine that an operation requires a token wallet associated with a unique identifier;
determine that the token wallet does not already exist;
generate the token wallet; and
associate a non-fungible token (NFT) with the token wallet.

9. The system of claim 8, wherein:
the operation is a first operation;
the unique identifier is a first unique identifier;
the token wallet is a first token wallet; and
the processor:
determines that a second operation requires a second token wallet associated with a second unique identifier;
identifies that a third token wallet associated with a third unique identifier is associated with a same person as the second unique identifier; and
uses the third token wallet instead of generating the second token wallet.

10. The system of claim 9, wherein the processor uses the third token wallet by creating a sub wallet in the third token wallet for the second operation.

11. The system of claim 9, wherein the processor identifies that the third token wallet associated with the third unique identifier is associated with a same person as the second unique identifier by determining that a same phone number is associated with both the third unique identifier and the second unique identifier.

12. The system of claim 8, wherein the unique identifier is a frequent flyer number.

13. The system of claim 8, wherein association of the NFT with the token wallet is usable in place of an access credential to access a computing device associated with a requestor of the operation.

14. The system of claim 8, wherein the operation is generation of the NFT.

15. A system, comprising:
a non-transitory storage medium storing instructions; and
a processor that executes the instructions to:
receive a digital photograph to send to a person associated with a unique identifier;
create a non-fungible token (NFT) and an associated smart contract relating to accessing the digital photograph;
generate a token wallet that is associated with the unique identifier; and
associate the NFT with the token wallet.

16. The system of claim 15, wherein the processor generates an access protected version of the digital photograph.

17. The system of claim 16, wherein the processor stores the access protected version of the digital photograph on a blockchain.

18. The system of claim 16, wherein:
the processor generates the access protected version of the digital photograph by encrypting the digital photograph; and
the NFT is usable to decrypt an encrypted version of the digital photograph.

19. The system of claim 16, wherein the processor generates the access protected version of the digital photograph by encrypting the digital photograph.

20. The system of claim 15, wherein the associated smart contract is operable to render the digital photograph no longer accessible.
